(19) United States
(12) Patent Application Publication
(10) Pub. No.: US 2005/0141674 A1
(43) Pub. Date: Jun. 30, 2005

(54) Monitoring a telephone call via conferencing

(76) Inventors: Garth Brown, Seattle, WA (US); Dylan Vanderhoof, Seattle, WA (US)

Correspondence Address: PERKINS COIE LLP;PATENT-SEA, P.O. BOX 1247, SEATTLE, WA, 98111-1247, US

(21) Appl. No.: 10/967,906

(22) Filed: Oct. 14, 2004

Related U.S. Application Data
(60) Provisional application No. 60/511,055, filed on Oct. 14, 2003.

(51) Int. Cl. H04N 7/14

(52) U.S. Cl. 379/32.01; 348/14.08

(57) ABSTRACT

A method for monitoring a telephone call between multiple devices via call conferencing is provided. A monitoring system receives a request from one of the devices of a telephone call to conference the monitoring system into the telephone call. The monitoring system arranges a conference call that includes the devices and the monitoring system itself. The monitoring system may arrange the conference call by requesting one of the devices to initiate a conference call that includes the monitoring system. The monitoring system then receives information sent between the devices as part of a conventional conference call. The monitoring system can record the information or take some other action based on the information.

### CROSS-REFERENCE TO RELATED APPLICATIONS

The present application claims priority to pending U.S. Provisional Application No. 60/511,055, entitled “Monitoring a Telephone Call Via Conferencing,” filed Oct. 14, 2003 and incorporated herein in its entirety by reference.

### BACKGROUND

In many environments, it is desirable to monitor and record telephone calls.

In a call center environment, for example, the call center may want to record each telephone call that is placed to the call center so that the quality of the service provided by the call center can be monitored and improved. The calls placed to the call center may be routed through a call center switch, such as a private branch exchange, that includes a recording module. The recording module may record various telephone calls based upon configuration parameters established by the call center. For example, the call center may want to monitor all the calls handled by a new employee or to monitor randomly selected calls. A disadvantage of the use of a recording module in each switch is the expense of having to purchase additional modules as the number of calls increase.

In many current environments, telephone calls are routed over a digital network using the Internet Protocol (“IP”). Such routing of telephone calls are referred to as “voice over IP.” The digital networks may include an ethernet network that connects various telephone devices and computer systems. The networks are typically implemented as a fabric of switches routing content from a source device to a destination network device. The difficulty with the recording of telephone calls placed through such a switched network is that there is no common point in the switched network through which all telephone calls are routed. Thus, a single device cannot be used to monitor all telephone calls. To overcome this difficulty, some providers of switches have developed a feature that allows each switch to be programmed to send data received on an incoming port not only through an outgoing port to its destination, but also to an external device, such as a recording device. Cisco Systems, Inc. provides a remote switched port analyzer (“RSPAN”) feature that allows for such directing of telephone calls to external devices. When the external device receives the telephone call data, it can record the data. A disadvantage of such a feature is that it adds to the cost and complexity of the switches, requires special-purpose and expensive devices to receive and record of the call data, and makes monitoring of encrypted calls difficult.

### BRIEF DESCRIPTION OF THE DRAWINGS

FIG. 1 is a block diagram illustrating devices of a voice over IP network in which conferencing is used to monitor calls.

FIG. 2 is a diagram illustrating messages sent when a conference call is established for monitoring.

### DETAILED DESCRIPTION

A method for monitoring a telephone call between multiple devices via call conferencing is provided. In one embodiment, a monitoring system receives a request from one of the devices of a telephone call (i.e., calling or called device) to conference the monitoring system into the telephone call. The monitoring system arranges a conference call that includes the devices and the monitoring system itself. The monitoring system may arrange the conference call by requesting one of the devices to initiate a conference call that includes the monitoring system. The monitoring system then receives information sent between the devices as part of a conventional conference call. The monitoring system can record the information or take some other action based on the information. Alternatively or in addition, the monitoring system may inject data into the conference call. For example, the monitoring system may announce the current time periodically during the conference call. Because the monitoring is performed as part of the conventional conferencing system, any call that can also be in a conference call can also be monitored, regardless of the number of devices participating in the call.

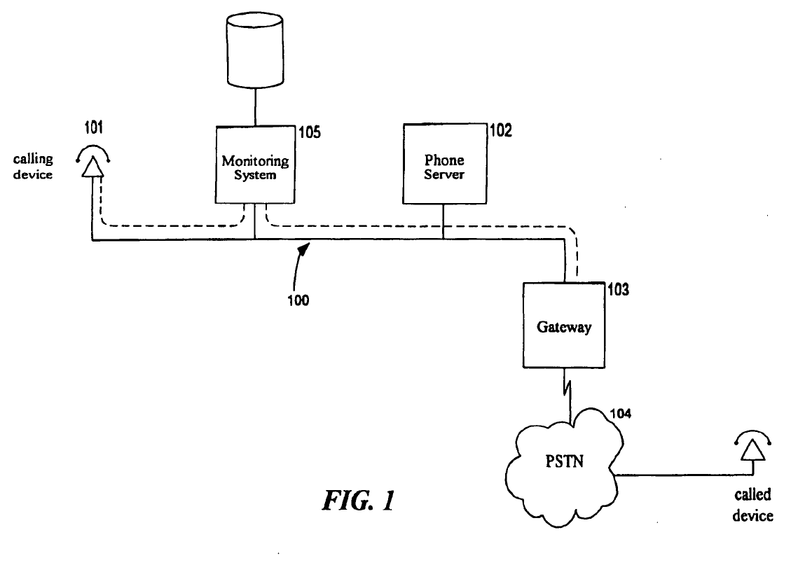

FIG. 1 is a block diagram illustrating devices of a voice over IP network in which conferencing is used to monitor calls. The IP network 100 connects a telephone 101, a phone server 102, and a gateway 103 in a conventional manner. When a telephone that is connected to the network places a call, a message is sent from the telephone to the phone server 102. The phone server determines whether the called device is on the local network or external to the network accessible via a gateway. If the called device is local to the network, the phone server provides the IP address of the called device to the calling device so that the calling device can contact the called device directly. If, however, the called device is external to the network, then the phone server provides the IP address of the gateway to the calling device. The calling device then sends a request to the gateway to establish a connection to the called device via the public switched telephone network (“PSTN”) 104. The gateway establishes the connection with the called device and then transfers the data from the calling device to the called device and from the called device to the calling device. One skilled in the art will also appreciate that the calling and called devices can be connected using a conventional time-division multiplexing (“TDM”) phone system. In that embodiment, a private branch exchange (“PBX”) that is connected to both the TDM phone system and the IP network translates the calls between them.

Regardless of whether the called device is accessed through the gateway or directly through the network, the calling device can initiate a conference call that includes the monitoring system 105. The monitoring system may be assigned a telephone number that is registered with the phone server. The calling device notifies the phone server that it wants to conference in the monitoring service. The phone server then establishes the conference call in which data from the calling device and called device is routed through the monitoring system. The monitoring system can then record the data or take other action as appropriate. In one embodiment, a person at the calling device can initiate the monitoring of the call between the calling device and the called device. Alternatively, the monitoring system or some other system can notify the calling device that the monitoring system should be conferenced in. The calling device can then initiate the conferencing in of the monitoring system. In this way, the monitoring may be essentially transparent to the user of the calling device. In one embodiment, the conferencing system may be modified to help ensure this transparency. For example, if the monitoring system is the only conferenced-in party, then the conferencing system may not provide any information to the calling device indicating that the call is being conferenced. The monitoring system can also use various rules to decide what calls to monitor. For example, the monitoring system could connect to, or be part of, the phone server so that it can identify the calling and called devices and monitor the calls based on the identifications. One skilled in the art will appreciate that the monitoring system can be conferenced in to a call that is placed by a calling device external to the network to a called device on the network.

Once the monitoring system is conferenced in to a telephone call, it can record the contents of a telephone call, inject content into the telephone call, or take other actions. For example, the monitoring system may transmit the content of the telephone call through the Internet to multiple parties who want to listen in on the telephone call. This transmission may be via broadcast, unicast, or multicast. As another example, the monitoring system can automatically inject disclaimers, notices, timing information, or other data into the conferenced call.

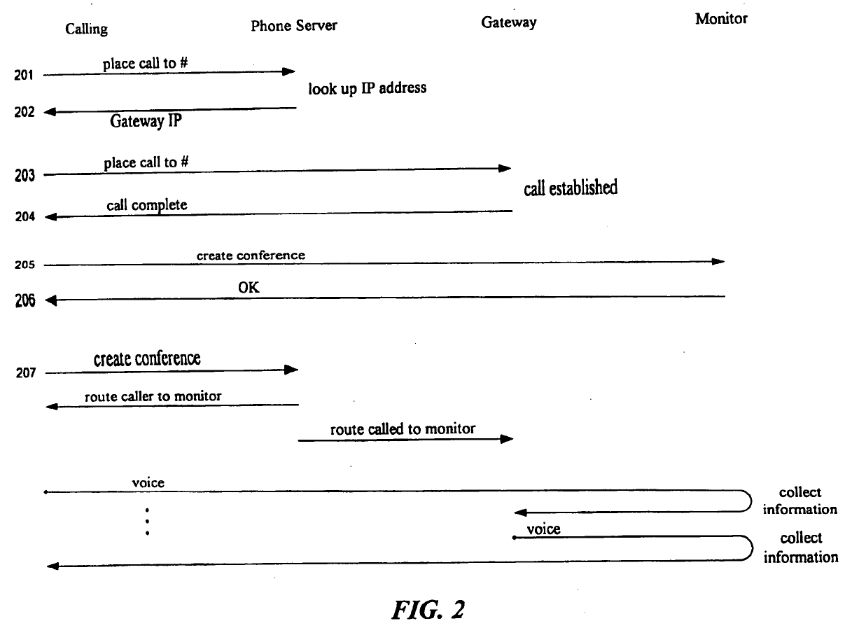

FIG. 2 is a diagram illustrating messages sent when a conference call is established for monitoring. Initially, the calling device sends 201 a message to the phone server requesting that a call be placed to a specified number. The phone server upon receiving the request looks up the IP address associated with the number. If the device associated with the call number is located on the local network, then the phone server returns the IP address of that device so that a connection can be made directly with that local device. If the device is not local, then the phone server returns 202 the IP address of the gateway. The calling device then sends 203 a request to place a call to the gateway. The gateway, upon receiving the request, places the call through the public switched telephone network. When a connection with the called device is established, the gateway sends 204 a response to the calling device indicating that the call has been established. At some point later, the calling device at the request of the user sends 205 a message to the monitoring system requesting that a conference with the monitoring system be created. The monitoring system then sends 206 a message to the calling device with an instruction to establish a conference call. The calling device then sends 207 a message to the phone server requesting that a conference call be created with the monitoring system. After the conference call is established, whenever the monitoring system receives data from the calling device, it processes the data (e.g., records the data) and forwards the data to the gateway. Whenever the monitoring system receives data from the gateway, it processes the data and forwards it to the calling device.

The computer systems, servers, and telephones may include a central processing unit, memory, input devices (e.g., keyboard and pointing devices), output devices (e.g., display devices), and storage devices (e.g., disk drives). The memory and storage devices are computer-readable media that may contain instructions that implement the monitoring system. In addition, data structures and message structures may be stored or transmitted via data transmission medium, such as a signal on a communications link. Various communications links may be used, such as the Internet, a local area network, a wide area network, or a point-to-point dial-up connection.

One skilled in the art will appreciate that although specific embodiments of the monitoring system have been described herein for purposes of illustration, various modifications may be made without deviating from the spirit and scope of the invention. For example, the monitoring system may be used to monitor calls from a calling device that is external to the local network of the monitoring system. The device that is external to the local network can be the calling or called device and can itself be on a local area network that is part of a wide area network connected to the local network via a network bridge. The monitoring system itself may also be remote to the IP network. For example, a service provider may provide monitoring services to multiple IP networks that may be owned and operated by different entities. In one embodiment, a participant, other than monitoring system, can be responsible for receiving and forward the data of the call. The conferencing function (e.g., receiving and forwarding the data of the call) can also be performed by a device that provides the conferencing functions but does not participate in the call. One skilled in the art will appreciate that the data of a conference can be any type of data, including voice data, video data, other digital data, encrypted data, and so on. Accordingly, the invention is not limited except as by the appended claims.

1. A method for monitoring a telephone call between two devices, comprising:
receiving a request from one of the devices to conference in a monitoring system;
establishing a conference call that includes the two devices and the monitoring system; and
under control of the monitoring system,
receiving the information sent between the two devices; and
recording the received information.
